(19) United States
(12) Patent Application Publication
(10) Pub. No.: US 2021/0003834 A1
(43) Pub. Date: Jan. 7, 2021

(54) METHOD AND APPARATUS FOR OPTICAL CONFOCAL IMAGING, USING A PROGRAMMABLE ARRAY MICROSCOPE

(71) Applicant: Max-Planck-Gesellschaft zur Foerderung der Wissenschaften e. V., Muenchen (DE)

(72) Inventors: Thomas M. JOVIN, Goettingen (DE); Anthony H. B. DE VRIES, Goettingen (DE); Donna J. ARNDT-JOVIN, Goettingen (DE)

(21) Appl. No.: 16/955,384

(22) PCT Filed: Dec. 20, 2017
(86) PCT No.: PCT/EP2017/083728

§ 371 Date: Jun. 18, 2020

(51) Int. Cl. G02B 21/00

(52) U.S. Cl. CPC G02B 21/008; G02B 21/0076; G02B 21/0048; G02B 21/0032

(57) ABSTRACT

Optical confocal imaging, being conducted with a programmable array microscope (PAM) (100), having a light source device (10), a spatial light modulator device (20) with a plurality of reflecting modulator elements, a PAM objective lens and a camera device (30), wherein the spatial light modulator device (20) is configured such that first groups of modulator elements (21) are selectable for directing excitation light to conjugate locations of an object to be investigated and for directing detection light originating from these locations to the camera device (30), and second groups of modulator elements (22) are selectable for directing detection light from non-conjugate locations of the object to the camera device (30), comprises the steps of directing excitation light from the light source device (10) via the first groups of modulator elements to the object to be investigated, wherein the spatial light modulator device (20) is controlled such that a predetermined pattern sequence of illumination spots is focused to the conjugate locations of the object, wherein each illumination spot is created by at least one single modulator element defining a current PAM illumination aperture, collecting image data of a conjugate image l_{c}, based on collecting detection light from conjugate locations of the object for each pattern of PAM illumination apertures, collecting image data of a non-conjugate image l_{nc}, based on collecting detection light from non-conjugate locations of the object for each pattern of PAM illumination apertures via the second groups of modulator elements (22) with a non-conjugate camera channel of the camera device (30), and creating an optical sectional image of the object (OSI) based on the image data of the conjugate image l_{c} and the non-conjugate image l_{nc}, wherein the step of collecting the image data of the conjugate image l_{c} includes collecting a part of the detection light from the conjugate locations of the object for each pattern of PAM illumination apertures via modulator elements of the second groups of modulator elements (22) surrounding the current PAM illumination apertures with the non-conjugate camera channel of the camera device (30). Furthermore, a PAM calibration method and PAMs being configured for the above methods are described.

### FIELD OF THE INVENTION

The present invention relates to optical confocal imaging methods which are conducted with a programmable array microscope (PAM). Furthermore, the present invention relates to a PAM being configured for confocal optical imaging using a spatio-temporally light modulated imaging system. Applications of the invention are present in particular in confocal microscopy.

### TECHNICAL BACKGROUND

EP 911 667 A1, EP 916 981 A1 and EP 2 369 401 B1 disclose PAMs which are operated based on a combination of simultaneously acquired conjugate (c, “in-focus”, I_{c}) and non-conjugate (nc, “out-of-focus”, I_{nc}) 2D images for achieving rapid, wide field optical sectioning in fluorescence microscopy. Multiple apertures (“pinholes”) are defined by the distribution of enabled (“on”) micromirror elements of a large (currently 1080p, 1920×1080) digital micromirror device (DMD) array. The DMD is placed in the primary image field of a microscope to which the PAM module, including light source device(s) and camera device(s), is attached via a single output/input port. The DMD serves the dual purpose of directing a pattern of excitation light to the sample and also of receiving the corresponding emitted light via the same micromirror pattern and directing it to a camera device. While DMDs are widely applied for excitation purposes, their use in both the excitation and detection paths (“dual pass principle”) is unique to the PAM concept and its realization. The “on” and off” mirrors direct the fluorescence signals to dual cameras for registration of the c and nc images, respectively.

In the conventional procedures, the signals generated by a given sequence of pattern were accumulated and read out as single exposures from cameras to allow maximal acquisition speed. However, the conventional PAM operation procedures may have limitations in terms of spatial imaging resolution, system complexity and/or restriction to measure usual simple fluorescence emissions. In particular, the camera device of the conventional PAM necessarily includes two camera channels, which are required for collecting the conjugate and non-conjugate images, resp. Furthermore, advanced fluorescence measurement techniques, in particular structured illumination fluorescence microscopy (SIM) (see J. Demmerle et al. in “Nature Protocols” vol. 12, 988-1010 (2017)) or single molecule localization fluorescence microscopy (SMLM) (see Nicovich et al. in “Nature Protocols” vol. 12, 453-460 (2017)) or superresolution fluorescence microscopy achieving resolution in fluorescence microscopy substantially below 100 nm cannot be implemented with conventional PAMs. Superresolution fluorescence microscopy includes e.g. selective depletion methods such as RESOLFT (see Nienhaus et al. in “Chemical Society Reviews” vol. 43, 1088-1106 (2014)), stochastic optical reconstruction microscopy (STORM, see Tam and Merino in Journal of Neurochemistry, vol. 135, 643-658 (2015)) or MinFlux (see C. A. Combs et al. in “Fluorescence microscopy: A concise guide to current imaging methods. Current Protocols in Neuroscience” 79, 2.1.1-2.1.25. doi: 10.1002/cpns.29 (2017); and Balzarotti et al. in “Science” 355, 606-612 (2017)).

### Objective of the Invention

The objective of the invention is to provide improved methods and/or apparatuses for confocal optical imaging, being capable of avoiding disadvantages of conventional techniques. In particular, the objective of the invention is to provide confocal optical imaging with increased spatial resolution, reduced system complexity and/or new PAM applications of advanced fluorescence measurement techniques.

### SUMMARY OF THE INVENTION

The above objectives are solved with optical confocal imaging methods and/or a spatio-temporally light modulated imaging system (programmable array microscope, PAM) comprising the features of one of the independent claims. Preferred embodiments and applications of the invention are defined in the dependent claims.

According to a first general aspect of the invention, the above objective is solved by an optical confocal imaging method, being conducted with a PAM, having a light source device, a spatial light modulator device with a plurality of reflecting modulator elements, a PAM objective lens and a camera device. The spatial light modulator device, in particular a digital micromirror device (DMD) with an array of individually tiltable mirrors, is configured such that first groups of modulator elements are selectable for directing excitation light to conjugate locations of an object (sample) to be investigated and for directing detection light originating from these locations to the camera device, and second groups of modulator elements are selectable for directing detection light from non-conjugate locations of the object to the camera device.

The optical confocal imaging method includes the following steps. Excitation light is directed from the light source device in particular via the first groups of modulator elements and via reflective and/or refractive imaging optics to the object to be investigated (excitation or illumination step). The spatial light modulator device is controlled such that a predetermined pattern sequence of illumination spots is focused to the conjugate locations of the object, wherein each illumination spot is created by one single modulator element or a group of multiple neighboring modulator elements defining a current PAM illumination aperture. Image data of a conjugate image I_{c} and image data of a non-conjugate image I_{nc} are collected with the camera device. The image data of the conjugate image I_{c} are collected by employing detection light from conjugate locations of the object (conjugate locations are the locations in a plane in the object which is a conjugate focal plane relative to the spatial light modulator surface and to the imaging plane(s) of the camera device(s)) for each pattern of illumination spots and PAM illumination apertures. The image date of the non-conjugate image I_{nc} are collected by employing detection light received via the second groups of modulator elements from non-conjugate locations (locations different from the conjugate locations) of the object for each pattern of illumination spots and PAM illumination apertures. An optical sectional image of the object (OSI) is created, preferably with a control device included in the PAM, based on the conjugate image I_{c} and the non-conjugate image I_{nc}. The control device comprises e.g. at least one computer circuit each including at least one control unit for controlling the light source device and the spatial light modulator device and at least one calculation unit for processing camera signals received from the camera device.

According to the invention, the step of collecting the image data of the conjugate image I_{c} includes collecting a part of the detection light from the conjugate locations of the object for each pattern of PAM illumination apertures via modulator elements of the second groups of modulator elements surrounding the current PAM illumination apertures with the non-conjugate camera channel of the camera device. Depending on the aperture size and the 3D distribution of absorbing/emitting species in the object to be investigated (sample), the conjugate I_{c} image may also include a fraction of detected light originating from non-conjugate positions of the sample. Conversely, the non-conjugate I_{nc} image may also contain a fraction of the detected light originating from the conjugate positions of the sample. According to the invention, the step of forming the OSI in particular is based on on computing the fractions of conjugate and non-conjugate detected light in the I_{c} and I_{nc} images and combining the signals. To achieve this end, the invention employs the characteristic of the excitation light that impinges not only on conjugate (“in-focus”) volume elements of the object, but traverses the object with an intensity distribution dictated by the 3D-psf (“3D point-spread function”, e.g. approximately ellipsoidal about the focal plane and diverging e.g. conically with greater axial distance from the focal plane) corresponding to the imaging optics, thereby generating a non-conjugate (“out-of-focus”) distribution of excited species. The inventor have found that due to the point spread function of the PAM imaging optics in the illumination and detection channels and in the case of operation with small PAM illumination apertures a substantial portion of the detection light from the conjugate locations of the object is directed to the non-conjugate camera channel where it is superimposed with the detection light from the non-conjugate locations of the object and that both contributions can be separated from each other. This provides both a substantial reduction of system complexity as the PAM can have only a single camera providing the non-conjugate camera channel, as well an increased resolution as the collection of light via the non-conjugate camera channel allows a size reduction of illumination apertures (illumination light spot diameters). The combination of small illumination apertures and efficient collection of the detected light leads to significant increases in lateral spatial resolution and in optical sectioning efficiency while preserving a high signal-to-noise ratio.

According to a second general aspect of the invention, the above objective is solved by an optical confocal imaging method, being conducted with a PAM, having a light source device, a spatial light modulator device with a plurality of reflecting modulator elements, a PAM objective lens and a camera device, like the PAM according to the first aspect of the invention. In particular, the spatial light modulator device is operated and the excitation light is directed to the object to be investigated, as mentioned with reference to the first aspect of the invention. A conjugate image I_{c} is formed by collecting detection light from conjugate locations of the object for each pattern of illumination spots and PAM illumination apertures via the first groups of modulator elements with a conjugate camera channel of the camera device, and a non-conjugate image I_{nc} is formed by collecting detection light from non-conjugate locations of the object for each pattern of illumination spots and PAM illumination apertures via the second groups of modulator elements with a non-conjugate camera channel of the camera device. The optical sectional image of the object is obtained based on the conjugate image I_{c} and the non-conjugate image I_{nc}.

According to the invention, the conjugate (I_{c}) and non-conjugate (I_{nc}) images are mutually registered by employing calibration data, which are obtained by a calibration procedure including mapping positions of the modulator elements to camera pixel locations of the camera device, in particular the cameras providing the conjugate and non-conjugate camera channels. The calibration procedure includes collecting calibration images and processing the recorded calibration images for creating the calibration data assigning each camera pixel of the camera device to one of the modulator elements.

Advantageously, applying the calibration procedure allows that summed intensities in “smeared” recorded spots can be mapped to single known positions in the spatial light modulator device (DMD array), thus increasing the spatial imaging resolution. Furthermore, the c and nc camera images are mapped to the same source DMD array and thus absolute registration of the c and nc distributions in DMD space is assured. These advantages can be obtained already by adding the calibration procedure to the operation of conventional PAMs. Particular advantages are provided if the calibration procedure is applied in embodiments of the optical confocal imaging method according the first general aspect of the invention as further outlined below.

According to a third general aspect of the invention, the above objective is solved by a PAM, having a light source device, a spatial light modulator device with a plurality of reflecting modulator elements, a PAM objective lens, relaying optics, a camera device, and a control device. Preferably, the PAM is configured to conduct the optical confocal imaging method according to the above first general aspect of the invention. The spatial light modulator device is configured such that first groups of modulator elements are selectable for directing excitation light to conjugate locations of an object to be investigated and for directing detection light originating from these locations to the camera device, and second groups of modulator elements are selectable for directing detection light from non-conjugate locations of the object to the camera device. The light source device is arranged for directing excitation light via the first groups of modulator elements to the object to be investigated, wherein the control device is adapted for controlling the spatial light modulator device such that a predetermined pattern sequence of illumination spots is focused to the conjugate locations of the object, wherein each illumination spot is created by at least one single modulator element defining a current PAM illumination aperture. The camera device is arranged for collecting image data of a conjugate image I_{c} by collecting detection light from conjugate locations of the object for each pattern of illumination spots and PAM illumination apertures. Furthermore, the camera device includes a non-conjugate camera channel which is configured for collecting image data of a non-conjugate image I_{nc} by collecting detection light from non-conjugate locations of the object for each pattern of illumination spots and PAM illumination apertures via the second groups of modulator elements. The control device is adapted for creating an optical sectional image of the object based on the conjugate image I_{c} and the non-conjugate image I_{nc}. The control device comprises e.g. at least one computer circuit each including at least one control unit for controlling the light source device and the spatial light modulator device and at least one calculation unit for processing camera signals received from the camera device.

According to the invention, the non-conjugate camera channel of the camera device is arranged for collecting a part of the detection light from the conjugate locations of the object for each pattern of illumination spots and PAM illumination apertures via modulator elements of the second group of modulator elements surrounding the current PAM illumination apertures. Preferably, the control device is adapted for extracting the conjugate image I_{c} as a contribution included in the non-conjugate image I_{nc}.

According to a fourth general aspect of the invention, the above objective is solved by a PAM, having a light source device, a spatial light modulator device with a plurality of reflecting modulator elements, a PAM objective lens, relaying optics, a camera device, and a control device. Preferably, the PAM is configured to conduct the optical confocal imaging method according to the above second general aspect of the invention. The spatial light modulator device is configured such that first groups of modulator elements are selectable for directing excitation light to conjugate locations of an object to be investigated and for directing detection light originating from these locations to the camera device, and second groups of modulator elements are selectable for directing detection light from non-conjugate locations of the object to the camera device. The light source device is arranged for directing excitation light via the first groups of modulator elements to the object to be investigated. The control device is adapted for controlling the spatial light modulator device such that a predetermined pattern sequence of illumination spots is focused to the conjugate locations of the object, wherein each illumination spot is created by at least one single modulator element defining a current PAM illumination aperture. The camera device has a conjugate camera channel (c camera) which is configured for forming a conjugate image I_{c} by collecting detection light from conjugate locations of the object for each pattern of illumination spots and PAM illumination apertures via the first groups of modulator elements. Furthermore, the camera device has a non-conjugate camera channel (nc camera) which is configured for forming a non-conjugate image I_{nc} by collecting detection light from non-conjugate locations of the object for each pattern of illumination spots and PAM illumination apertures via the second groups of modulator elements. The control device is adapted for creating an optical sectional image of the object based on the conjugate image I_{c} and the non-conjugate image I_{nc}.

According to the invention, the control device is adapted for registering the conjugate (I_{c}) and non-conjugate (I_{nc}) images by employing calibration data, which are obtained by a calibration procedure including mapping positions of the modulator elements to camera pixel locations.

According to a preferred embodiment of the invention, the spatial light modulator device is controlled such that the current PAM illumination apertures have a diameter approximately equal to or below M*λ/2NA, with λ being a centre wavelength of the excitation light, NA being the numerical aperture of the objective lens and M a combined magnification of the objective lens and relay lenses between the modulator apertures and the object to be investigated.

Advantageously, the PAM illumination apertures have a diameter equal to or below the diameter of an Airy disk (representing the best focused, diffraction limited spot of light that a perfect lens with a circular aperture could create), thus increasing the lateral spatial resolution compared with conventional PAMs and confocal microscopes. According to a particularly preferred embodiment of the invention each of the current PAM illumination apertures has a dimension less than or equal to 100 μm.

The number of modulator elements forming one light spot or PAM illumination aperture can be selected in dependency on the size of the modulator elements (mirrors) of the DMD array used and the requirements on resolution. If multiple modulator elements form the PAM illumination aperture, they preferably have a compact arrangement, e.g. as a square. Preferably, each of the PAM illumination apertures is created by a single modulator element. Thus, advantages for maximum spatial resolution are obtained.

According to a further advantageous embodiment of the invention, the camera device further includes a conjugate camera channel (conjugate camera) additionally to the non-conjugate camera channel. In this case, the step of forming the conjugate image I_{c} further includes forming a partial conjugate image I_{c} by collecting via the first groups of modulator elements detection light from the conjugate and the non-conjugate locations of the object for each pattern of illumination spots and PAM illumination apertures with the conjugate camera channel, extracting the partial conjugate image I_{c} from the image collected with the conjugate camera channel, and forming the optical sectional image by superimposing the partial conjugate image I_{c} and the contribution extracted from the non-conjugate image I_{nc}. Advantageously, with this embodiment, the optical sectional image comprises all available light from the conjugate locations, thus improving the image signal SNR.

Preferably, for each of the PAM illumination apertures, individual modulator elements of the PAM illumination apertures (included in or surrounding the PAM illumination aperture) define a conjugate or non-conjugate camera pixel mask surrounding a centroid of the camera signals of the respective conjugate or non-conjugate camera channel of the camera device corresponding to the PAM illumination aperture. Each respective conjugate or non-conjugate camera pixel mask is subjected to a dilation and estimations of respective background conjugate or non-conjugate signals are obtained from the dilated conjugate or non-conjugate camera pixel masks for use as corrections of the conjugate (I_{c}) and non-conjugate (I_{nc}) images. Advantageously, the formation and dilation of the mask provides additional background information improving the image quality.

According to a particularly preferred embodiment of the optical confocal imaging method according to the first general aspect of the invention, a calibration procedure is applied, including the steps of illuminating the modulator elements with a calibration light source device, creating a sequence of calibration patterns with the modulator elements, recording calibration images of the calibration patterns with the camera device, and processing the recorded calibration images for creating calibration data assigning each camera pixel of the camera device to one of the modulator elements. The calibration light source device comprises e.g. a white light source or a colored light source, homogeneously illuminating the spatial light modulator device from a front side (instead of the fluorescing object). With the calibration procedure, a major technical challenge of PAM operation is solved, which is the accurate registration of the two c and nc images.

Preferably, the calibration patterns include a sequence of e.g. regular, preferably hexagonal, matrices of light spots each being generated by at least one single modulator element, said light spots having non-overlapping camera responses. In other words, according to a preferred embodiment of using the calibration in all aspects of the invention, the separation of selected modulator elements is such that corresponding distribution of evoked signals recorded by the camera device is distinctly isolated from that of the neighboring distributions. Advantageously, the recorded spots in the camera images are sufficiently separated without overlap so that they can be unambiguously segmented. Hexagonal matrices of light spots are particularly preferred as they have the advantage that the single modulator elements are equally and sufficiently distant from each other in all direction within the camera detector plane, so that collecting single responses from single modulator elements with the camera is optimized.

According to a further preferred embodiment of using the calibration in all aspects of the invention, the number of calibration patterns is selected such that all modulator elements are used for recording the calibration images and creating the calibration data. Advantageously, this allows a calibration completely covering the spatial light modulator device.

According to another preferred embodiment of using the calibration in all aspects of the invention, the sequence of calibration patterns is randomized such that the separation between modulator elements of successive patterns is maximized. Advantageously, this allows to minimize temporal perturbations (e.g. transient depletion) of neighboring loci.

As a further advantage of the invention, the camera pixels of the camera device (c and/or nc channel) responding to light received from the individual modulator elements, i.e. the pixelwise camera signals, preferably provide distinct, unique and stable distributions of relative camera signal intensities associated with their coordinates in the matrix of camera pixels, which are mapped to the corresponding modulator elements using the calibration procedure. The distribution is described with a system of linear equations defining the response to an arbitrary distribution of intensities originating from the modulator elements.

Advantageously, various mapping techniques are available. According to a first variant (centroid method), all collected calibration pattern images are accumulated (superimposing of the image signals of the whole sequence of illumination patterns) and camera signals are mapped back to their corresponding originating modulator elements, wherein centroids of the camera signals define a local sub-image in which intensities are combined by a predetermined algorithm, like e.g. the arithmetic or Gaussian mean value of a 3×3 domain centered on the centroid position, so as to generate a signal intensity assignable to the corresponding originating modulator image element. The same procedure is applied independently to the conjugate and non-conjugate channels, resulting in a registration of the two in the coordinate system of the modulator elements

According to a second variant (Airy aperture method), all collected images are accumulated and camera signals are mapped back to their corresponding originating modulator elements again. The image signals of the whole sequence of illumination patterns are superimposed. The illumination patterns comprise illuminations apertures with a dimension which is comparable with the Airy diameter (related to the centre wavelength of the excitation light). In this case, every signal at every position in the image resulting from overlapping camera responses to an entire pattern sequence is represented with the linear equation with coefficients known from the calibration procedure, and the corresponding emission signals impinging on the corresponding modulator elements are obtained by the solution to the system of linear equations describing the entire image. Accordingly, the camera signals representing the responses of individual modulator elements are mapped back to their corresponding coordinates in the modulator matrix, such that the signal at every position in the image resulting from the overlapping responses to an entire pattern sequence can be represented as a linear equation with known coefficients and the emission signals impinging on the corresponding modulator elements contributing to the particular position (coordinates), wherein these signals are evaluated by the solution to the system of linear equations describing the entire image. Advantageously, by employing the system of linear equations, the fluorescence imaging is obtained with improved precision.

With a particular application of the invention, simultaneous or time-shifted excitation with the same pattern with one or more light sources applied from a contralateral side relative to a first excitation light source and the spatial light modulator device is provided. Contrary to conventional techniques, wherein the excitation light is provided from one side only, this embodiment allows the excitation from at least one second side. At least one second excitation light source can be used for controlling the local distribution of excited states in the object, in particular reducing the number of excited states in the conjugate locations or in the non-conjugate locations. Advantageously, this embodiment allows the application of advanced fluorescence imaging techniques, such as RESOLFT, MINFLUX, SIM and/or SMLM.

Accordingly, with a preferred embodiment of the invention the light source device comprises a first light source being arranged for directing excitation light to the conjugate locations of the object and a second light source being arranged for directing excitation light to the non-conjugate locations of the object, and the second light source is controlled for creating the excitation light such that the excitation created by the first light source is restricted to the conjugate locations of the object. In particular, the second light source can be controlled for creating a depleted excitation state around the conjugate locations of the object.

Furthermore, the detected light from the object can be a delayed emission, such as delayed fluorescence and phosphorescence, such that aperture patterns of modulator elements for excitation and detection can be distinct and experimentally synchronized.

If according to a further preferred embodiment of the invention, the first groups of modulator elements consist of 2D linear arrays of a low number (limit of 1) elements and the camera signals of individual modulator elements constitute a distinct, unique, stable distribution of relative signal intensities with coordinates in the matrix of camera pixels and in the matrix of modulation elements defined by the calibration procedure, further advantages for applying the advanced fluorescence techniques can be obtained.

The invention has the following further advantages and features. The inventive PAM allows fast acquisition, large fields, excellent resolution and sectioning power, and simple (i.e. “inexpensive”) hardware. Both excitation and emission point spread functions can be optimized without loss of signal.

According to further aspects of the invention, a computer readable medium comprising computer-executable instructions controlling a programmable array microscope for conducting one of the inventive methods, a computer program residing on a computer-readable medium, with a program code for carrying out one of the inventive methods, and an apparatus, e.g. the control device apparatus comprising a computer-readable storage medium containing program instructions for carrying out one of the inventive methods are described.

### BRIEF DESCRIPTION OF THE DRAWINGS

Further advantages and details of preferred embodiments of the invention are described in the following with reference to the attached drawings, which show in:

FIG. 1: a schematic overview of the illumination and detection light paths in a PAM according to preferred embodiments of the invention;

FIG. 2: a flowchart illustrating a calibration procedure according to preferred embodiments of the invention;

FIG. 3: illustrations of an example of single aperture mapping used in a calibration procedure according to preferred embodiments of the invention;

FIG. 4: experimental results representing a comparison of registration methods in a calibration procedure according to preferred embodiments of the invention;

FIG. 5: illustrations of creating a dilated mask for processing of conjugate and non-conjugate single aperture images according to preferred embodiments of the invention; and

FIG. 6: further experimental results obtained with optical confocal imaging methods according to preferred embodiments of the invention

### PREFERRED EMBODIMENTS OF THE INVENTION

The following description of preferred embodiments of the invention refers to the implementation of the inventive strategies of individual image acquisitions, while trading speed for enhanced resolution, on the basis of three PAM operation modes, all of which retain optical sectioning. They incorporate acquisition and data processing methods that allow operation in three steps of improving lateral resolution of imaging. The first PAM operation mode (or: RES1 mode) is based on employing the inventive calibration, resulting in a lateral resolution equal to or above 200 nm. The second PAM operation mode (or: RES2 mode) is based on employing the inventive extraction of the conjugate image from the non-conjugate camera channel, allowing a reduction of the illumination aperture and resulting in a lateral resolution in a range from 100 nm to 200 nm. The third PAM operation mode (or: RES3 mode) is based on advanced fluorescence techniques, resulting in a lateral resolution below 100 nm. It is noted that the calibration in RES1 mode is a preferred, but optional feature of RES2 and RES 3 modes, which alternatively can be conducted on the basis of other prestored reference data including the distribution of camera pixels “receiving” the conjugate and non-conjugate signals from single modulator elements.

These three ranges of enhanced resolution correspond to those achieved, respectively, by conventional confocal microscopy, the family of “SIM” techniques, and selective depletion methods such as RESOLFT, or further methods, like FLIM, FRET, time-resolved delayed fluorescence or phosphorescence, hyperspectral imaging, minimal light exposure (MLE) and/or tracking. Advantageously, no physical alteration of the instrument is required to switch between these modes. It is noted that the above three operation modes can be implemented separately, e.g. RES1 mode or RES2 mode or RES3 mode alone, or in combination e.g. the RES3 mode, including the features of RES2. Accordingly, each operation mode alone and any combination are considered as an independent subjects of the invention.

The description refers to a PAM including a camera device with two cameras. It is noted that a single camera embodiment can be used with an alternative embodiment, in particular, if the calibration is omitted as prestored calibration data are available and if the optical sectional image is extracted from the non-conjugate camera only.

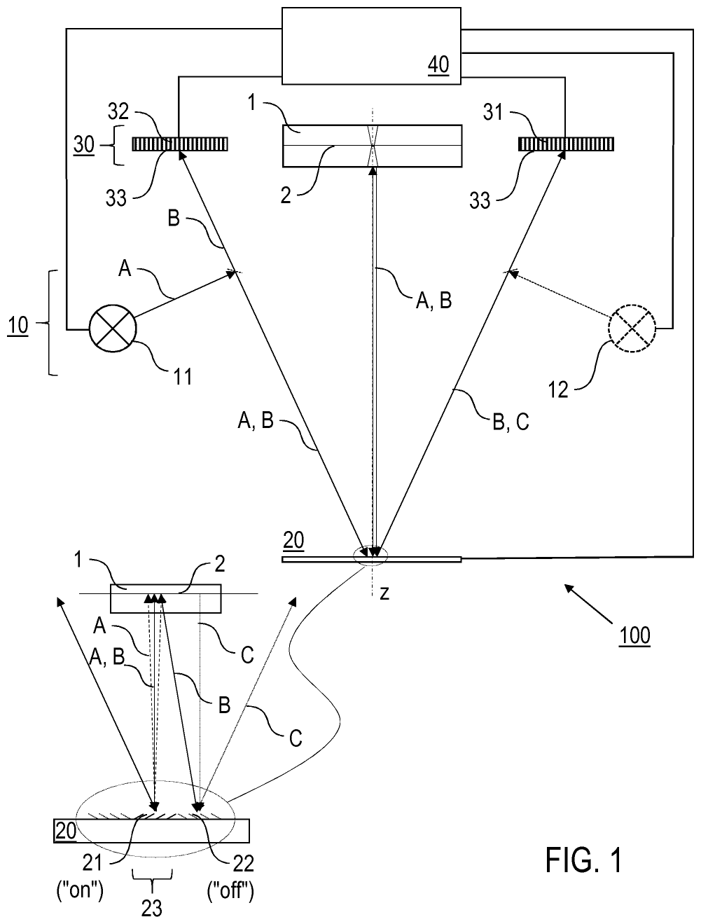

The following description of the operation modes refers to the implementation of the calibration procedure, conjugate image extraction and advanced fluorescence techniques employing a PAM. FIG. 1 schematically illustrates components of a PAM 100 having a light source device 10 including one or two light sources 11, 12, like e.g. semiconductor lasers, a spatial light modulator device, like a DMD array 20, with a plurality of tiltable reflecting modulator elements 21, 22, a camera device 30 with one non-conjugate camera 31 or two conjugate and non-conjugate camera 31, 32, and a control device 40 connected with the components 10, 20 and 30. Further details of a PAM, like a microscope body, an objective lens, relaying optics and a support of the object 1 (sample) to be investigated, are not shown in the schematic illustration. Details of the PAM which are known as such, like e.g. the optical setup, the control of the spatial light modulator device, the collection of the camera signals and the creation of the optical sectional image from conjugate and non-conjugate images, are implemented as it is known from conventional PAMs. The disclosure of EP 2 369 401 A1 is herewith incorporated by reference to the present specification, in particular with regard to the structure and operation of the PAM as shown in FIGS. 1, 2, 4 and 5 and the description thereof and the design of the imaging optics.

With more details, the DMD array 20 comprises an array of modulator elements 21, 22 (mirror elements) arranged in a modulator plane of the PAM 100, wherein each of the modulator elements can be switched individually between two states (tilting angles, see enlarged section of FIG. 1). For example, binary 1080p (high definition) patterns are generated at a frequency of e.g. approximately 16 kHz. The imaging optics (not shown in FIG. 1) are arranged for focusing the illumination light A (via the “on” tilt state) from the DMD array 20 onto the object 1 in the PAM 100 and relaying the emission light created in the object in response to the illumination light towards the DMD. The latter divides the detected light into two paths corresponding to the tilt angle of each micromirror. One detector camera 32 is arranged for collecting the so-called “conjugate” light (originating from the “on” mirrors) and a second camera 31 for detecting the “non-conjugate light (originating from mirrors in the “off” position). The two images are combined in real time by a simple subtraction procedure (after registration and distortion correction) so as generate an optically-sectioned image, similar to the “confocal” images produced by point scanning systems. However, the excitation duty cycle of the PAM is orders of magnitude higher, thus leading to the very high frame rates required for living systems.

Light beams from the light sources 11, 12 via the DMD array 20 to the object 1 and back via the DMD array 20 to the cameral 31, 32 are represented in FIG. 1 by lines only. In practice, a broad illumination covering the full surface of the DMD array 20 is provided, wherein the DMD array 20 is controlled such that patterns of illuminations spots are directed to the object 1 and focused in the focal plane 2 thereof. Thus, in practice, each illuminations spot creates a line beam path as illustrated in FIG. 1.

The DMD array 20 (see enlarged schematic illustration in FIG. 1) can be controlled such that first groups of modulator elements, e.g. 21, are selectable for directing excitation light A to conjugate locations in the focal plane 2 of the object 1 and for directing detection light B originating from these locations to the camera device 30, in particular to the non-conjugate camera 31 and optionally also to the conjugate camera 32. Furthermore, the DMD array 20 can be controlled such that second groups of modulator elements, e.g. 22, are selectable for directing detection light C from non-conjugate locations of the object to the camera device 30, in particular to the non-conjugate camera 31. Additionally, the second groups of modulator elements, e.g. 22, direct detection light B originating from the conjugate locations to the non-conjugate camera 31 as describe below with reference to the RES2 mode. Each group of modulator elements comprises a pattern of illumination apertures 23, each being formed by one single modulator element 21 or a group of modulator elements 21.

The cameras 31, 32 comprise matrix arrays of sensitive camera pixels 33 (e.g. a CMOS cameras), which collect detection light received via the modulator elements 21, 22. With the calibration procedure of the RES1 mode, the camera pixels 33 are mapped to the modulator elements 21, 22 of the DMD array 20.

Preferably, a functional software is running in the control device 40 (FIG. 1), that allows to control and setup all connected components, in particular units 10, 20 and 30, and performs fully automated image acquisition. It also includes the further image processing (image distortion correction, registration and subtraction) that is provided to produce the optical sectioned PAM image. The control device 40 allows the integration of the PAM modes such as for example superresolution.

The control device 40 performs the following tasks. Firstly, it communicates with (including control and setup), all the connected hardware (DMD array 20 controller, one or two cameras 32, 31, filter wheels, LED and/or laser excitation light sources 11, 12, microscope, xy micromotor stage and z-piezo stage). Secondly, it instructs the hardware to perform specific operations unique to the PAM 100, including a display of (a multitude of) binary patterns on the DMD array 20, combined with the synchronous acquisition of the result of the patterned fluorescence due to these patterns (conjugate and non-conjugate images) on one or two cameras 32, 31. The synchronization of display and acquisition is performed by hardware triggering, which is controlled by the integrated FPGA on the DMD controller board using a proprietary scripting language. Specific scripts have been developed for the different acquisition modalities. The application software assembles the required script on bases of the acquisition protocol and parameters. Thirdly, the control device 40 will process the acquired conjugate and non-conjugate images, performing background and shading correction, a non-linear distortion correction, image registration, and finally subtraction (large apertures) or scaled combinations (small apertures), to produce the optically-sectioned PAM image (OSI). The application software is written e.g. with

National Instruments LabVIEW language. It can acquire images up to the full bandwidth of both cameras 32, 31 (e.g. 4K, 16 bit, 100 fps), while providing live view on the conjugate/non-conjugate images at e.g. >25 fps. Captured conjugate and non-conjugate images are first stored in a RAM buffer, and processed asynchronously afterwards. Hence, the software can guarantee maximum acquisition performance, limited only by the bandwidth of the cameras.

RES1 Mode—Calibration Procedure

The calibration procedure is based on the following considerations. A single illumination aperture (virtual “pinhole”) in the image plane of the PAM 100 defines the excitation point-spread function (psf) in the focal plane 2 of the PAM 100 in the object 1. At the same time, it presents a geometrical limitation to the elicited emission passing to the camera behind it (the source of the term “confocal”). The signal emanating from an off-axis point in the focal plane 2 traverses the aperture 23 with an efficiency dependent on the pinhole diameter and the psf corresponding to the PAM optics and the emission wavelength. Out-of focus signals arising from positions removed from the focal plane and/or optical axis are attenuated to a much greater degree, thus providing Z-axis sectioning. The pinhole also defines the lateral and axial resolution, which improve as the size diminishes albeit at the cost of reduced signal due to loss of the in-focus contribution. In most conventional confocal systems the aperture sizes are set to approximately the Airy diameter defined by the psfs, thereby providing an acceptable tradeoff between resolution and recorded signal strength. The diffraction limited lateral resolution in the RES1 mode is given by M*λ/2NA (λ: centre wavelength of the excitation light A, NA: numerical aperture of the PAM objective lens, and M: combined magnification of the PAM objective lens and relay lenses between the modulator elements and the object 1), e.g. about 200 to 250 nm. The axial resolution is about 2 to 3× lower. In the conventional PAM this condition is achieved with square scanning apertures of 5×5 or 6×6 DMD modulator elements 21, 22 and duty cycles of 33 to 50%. Very fast acquisition and high intensities are achieved under these conditions; larger apertures degrade both axial and lateral resolution.

The conventional confocal arrangements discard the light rejected by the pinhole. In contrast and as stated earlier, the PAM collects both the out-of-focus (of, nc image) and the in-focus (if, c image) intensities. The recent insight of the inventors is to find what happens in PAM operation with small aperture sizes, i.e. a number of DMD elements (1×1, 2×2, 3×3) corresponding to a size smaller than the Airy disk. In this endeavor the inventors have resorted to the calibration procedure for defining the optical mapping of the DMD array 20 surface to the images of the cameras 31, 32. With this step, awkward, imprecise and time-demanding geometric dewarping calculations required for achieving the c-nc registration are avoided.

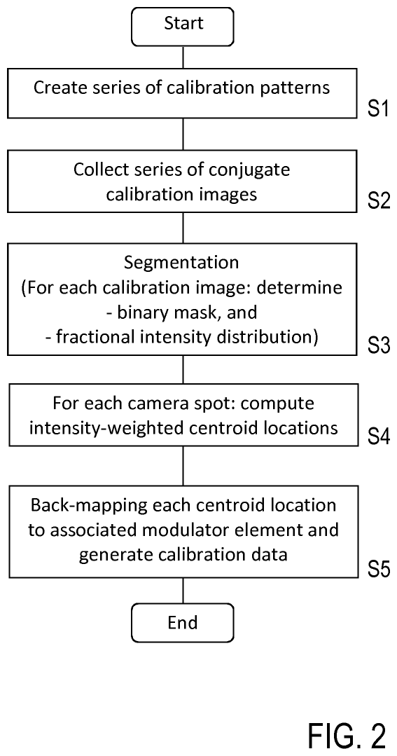

The calibration procedure (see FIG. 2) comprises single aperture mapping (SAM) of DMD modulator elements 21, 22 to camera pixels 33 and vice-versa. In the PAM 100, the “real” images of the fluorescence originating from the object 1 are given by the distribution of fluorescence impinging on the DMD array 20 and its correspondence to the “on” (21) and “off” (22) mirror elements. In a way, the cameras 31, 32 are merely recording devices and ideally serve to reconstruct the desired DMD distribution. Thus, the calibration procedure provides a means for systematically and unambiguously backmapping the camera information to the DMD array source in a manner that ensures coincidence of the constituent pairs of c and nc contributions at the level of single modulator elements. The same procedure is applied to the conjugate and non-conjugate channels.

In the new SAM registration method, a series of calibration patterns consisting of single modulator elements 21 (“on” mirrors, focusing light to the focal plane) is generated, which are organized in a regular lattice with a certain pitch (step S1). A preferred choice is a hexagonal arrangement in which every position is equidistant from its 6 neighbors (FIG. 2). Other lattice geometries are alternatively possible. The DMD array 20 is frontally illuminated (for example from the microscope bright field light source (not shown in FIG. 1) operated in Köhler transmission mode) such that the “on” pixels of the pattern lead to an image in the c camera 32 (in this case the nc signals are not relevant). To obtain the corresponding information for the nc channel, one employs the complementary pattern and records the image with the nc camera 31. This procedure is repeated for a sequence of about 80 to 200 bitplanes required for full coverage (step S2). Thus, a pitch of 10, typical for arrays of single DMD elements 21, 22, requires 100 bitplane images, each with about 15000 “on” elements shifted globally by unitary x,y DMD increments in the sequence.

The order of the bitplanes so defined is generally randomized so as to minimize temporal perturbations (e.g. transient depletion) of neighboring loci. The recorded spots in the camera images are sufficiently separated (without overlap) so that they can be unambiguously segmented. One determines the binary mask as well as the fractional intensity distribution among the pixels (about 20) that encompass the entire signal for a given spot (step S3). One also determines total intensities (step S3) and computes the intensity-weighted centroid locations for each spot (step S4). Subsequently, the backmapping of each centroid location to the DMD element from which its signal originates is provided and calibration data representing the backmapping information are calculated (step S5). This can be done with standard software tools, like the software Mathematica. The calibration data comprise assigns labels to the camera pixels and/or modulator elements and mapping vector data mutually referring the camera pixels and modulator elements to each other.

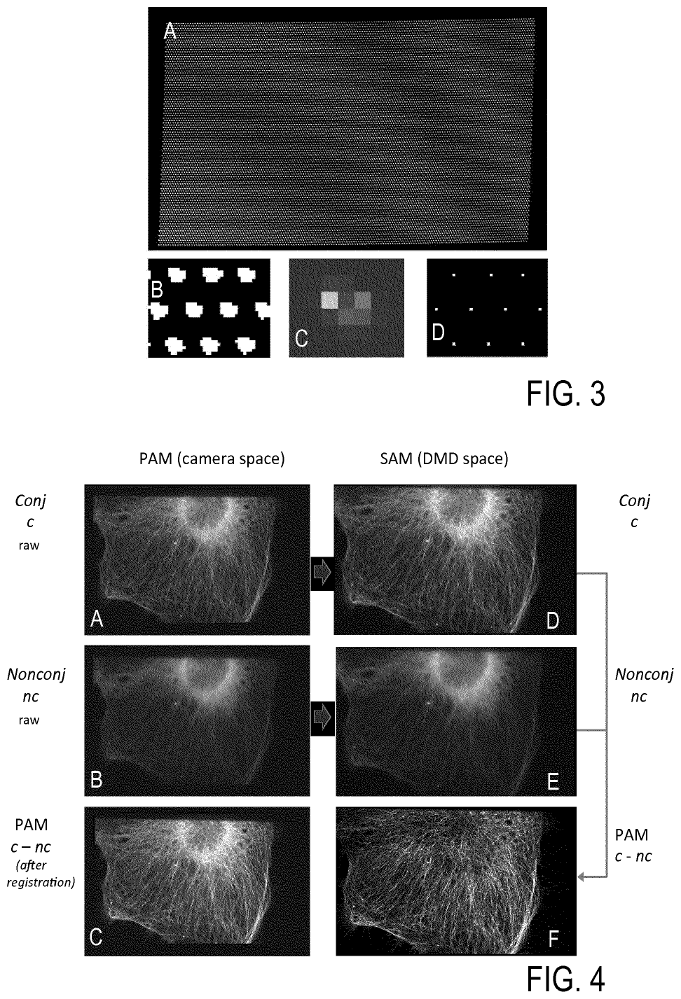

FIG. 3 shows an example of single aperture mapping. The top image (FIG. 3A) is recorded by the c camera 32 for a complete array of individual apertures (95 rows and 157 columns, a total of 14915 spots per bitplane). The binary mask (FIG. 3B) depicts spots selected from the top image; approximately 20 camera pixels display finite values above background. The gray value distribution of one such spot, shown in FIG. 3C, is distinctive, reproducible and stable if the PAM optics are not readjusted. The computed centroid positions (FIG. 3D) correspond to the array depicted in the binary mask.

The procedure has a number of advantages: (1) the summed intensities in “smeared” recorded spots can be mapped to single known positions in the DMD array 20; (2) the camera only needs to have a resolution and format large enough to allow an accurate (and stable) segmentation of the calibration (and later, sample) spots. A high QE, low noise, and field uniformity are other desirable features. Sharp and fairly uniform focusing is important but relative rotation and translation are not; the two cameras can even be different since both are mapped back to the same DMD modulator elements; (3) the total calibration intensities allow the calculation of a very accurate shading correction for later use; (4) the c and nc camera images are mapped to the same source array 20 and thus absolute registration of the c and nc distributions in DMD space is assured; and (5) using the RES1 mode of superposing all the bitplane signals in a single exposure and readout, the registration procedure is also valid under these conditions because the overlapping intensity distribution patterns can be summed so as to form linear equations for each camera pixel. In these equations, the variables are the DMD intensities of interest and the coefficients are known from the calibration. The equation matrix is stored (for recall during operation) and the system solved separately for every pattern of recorded intensities, i.e. the arbitrary c and nc image pairs arising individually or in a z-scan series, for example.

A an alternative, less precise but useful simplification of SAM involves backmapping of the intensities at the centroid positions and/or the means of a small submatrix of pixel values (e.g. a 3×3 domain) about each centroid. This alternative SAM registration procedure is very fast and yields sufficient results, exceeding the resolution and sectioning capacity experimentally achieved to date with conventional linear or nonlinear geometric dewarping methods available in LabVIEW Vision.

A comparison of the SAM registration procedures is given in FIG. 4 with the imaging of 3T3 Balbc mouse fibroblasts stained for α-tubulin and counter-stained with an Alex488-GAMIG. FIGS. 4A to 4C show the registration procedure by geometric dewarping. FIGS. 4D to 4F show the registration by SAM. Scanned with PAM sequence 5_50 (5×5 apertures in a random distribution with 50% duty cycle). Due to the improved registration, optical sectioning is much improved. The same acquired data were utilized in both procedures.

RES2 Mode—Conjugate Image Extraction Procedure

In the RES2 mode, the PAM is configured for procedures which are known in the literature as “structured illumination (SIM)” or as “pixel relocation” for increasing lateral and/or axial resolution up to 2× by reinforcing higher spatial frequencies. Advantageously, this results in an expansion of lateral resolution to the 100 to 200 nm range. Similar to the generally known “Airy” detector of the confocal microscope LSM800 (manufacturer Zeiss), the concept is to exploit numerous off-axis sub Airy-disk apertures (detectors) in a manner that enhances higher spatial frequencies but avoids the unacceptable signal loss from very small pinholes in point scanning systems, as discussed above. The PAM implementation, however, avoids the complex detector assembly and multi-element post-deconvolution and relocation processing of the Zeiss Airy system.

In the PAM, the physical aperture (pinhole) of the conventional confocal microscope is replaced by the at least one modulator element of the spatial light modulator device (DMD array). Thus, an “aperture” can consist of a single element or a combination of elements, e.g. in a square or pseudo-circular configuration or in a line of adjustable thickness. In the conventional confocal microscope, a “small” pinhole provides increased resolution due an increase in spatial bandwidth, represented in the 3D point-spread-function (psf), the image of a point-source, or, more directly in its Fourier transform, the 3D optical transfer function (otf), in which the “missing cone” of the widefield microscope is filled in. However, since the pinhole is “shared” in excitation and emission the smaller the size the less emission signal intensity is captured, lowering the signal-to-noise ratio accordingly (the pinhole physically rejects the emitted light arriving outside of the pinhole).

On the contrary, in the PAM, the emission “returning” from the object in the microscope is registered by the conjugate camera (via the single “on” modulator element defining the aperture) and also by the array of “off” modulator elements around the single modulator element, which direct the light to the non-conjugate camera. That is, all the detection light B from conjugate locations is collected, and the illumination aperture size determines the fraction going to the one or the other camera 31, 32 (see FIG. 1). For very small apertures, e.g. single elements, most of in-focus (if) as well as out-of-focus (of) signal goes to the non-conjugate camera 32.

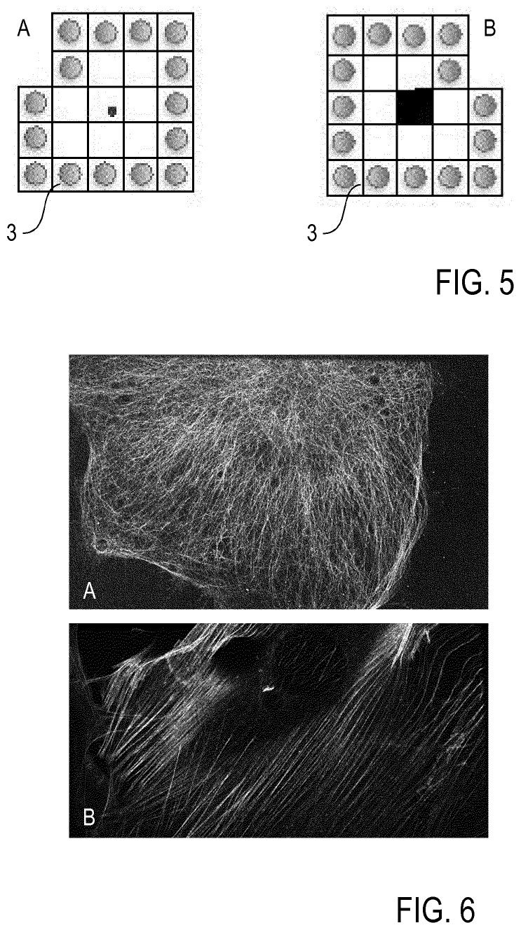

The single aperture calibration method of RES1 mode serves to define the distribution of camera pixels “receiving” the conjugate and non-conjugate signals from single modulator element apertures. In the calibration, a set of complementary illumination patterns are used to determine the distributions (binary masks) in both channels (cameras) for every individual micromirror position. The c and nc “images” (FIG. 3) defined above are processed in parallel as follows (see also FIG. 5 and Scheme 1 below for more details).

The binary masks established from the calibration (FIG. 5) are dilated 1× so as to define a ring of pixels surrounding the response area established from the calibration (FIG. 5). In the c channel (camera 32), the intensities in the “ring” mask 3 correspond exclusively to the standard background of the camera image (electronic bias+offset), since by definition the in-focus (if) signal and any associated out-of-focus (of) signal corresponding to a given aperture are constrained to the “core” pixels defined by the initial binary mask. A mean background/pixel value (b) is computed from the “ring” pixels of mask 3 and used to calculate the total background contribution (b-number of core pixels). Subtraction yields the RES2 mode c image.

In the case of the nc channel (camera 31), the signal consists of the majority of the if signal, as indicated above, as well as the of contributions corresponding to the given position and its conjugate in the sample. In this case, the intensities in the ring pixels of mask 3 (after dilation) contain the camera background but also the of components, which are expanded and extend beyond the confines of the calibration mask and thus provide the means for correcting the core response by subtraction.

This net nc signal (and the total image formed by all the apertures processed for each illumination bitplane), contains the desired if information with the highest achievable resolution (2x compared to widefield) and degree of sectioning provided by the small aperture and defines the RES2 mode (100-200 nm) of 3D resolution.

Since most of the desired signal is contained in the nc channel (the relationship between the c and nc intensities is about 1/9 in the case of our present instrument), the PAM 100 can be operated in this mode using only the single nc camera 31 (FIG. 1). However, the c and nc images collected with nc camera 31 and c camera 32 can also be added so as to yield the total in-focus (if) emission, albeit at the cost of additional noise. A simplified algebraic description of these relationships is given in FIG. 5 and Scheme 1 and examples of RES2 mode imaging in FIG. 6.

It is also worth noting that the intensities in the final images (in DMD array space) are much higher than in the conventional camera images because the procedure integrates the entire response (which is dispersed in the recorded images) into a single value deposited at the coordinate in the final image corresponding to the DMD element of origin. As an additional benefit, these methods can be conducted with excitation light sources including LED instead of laser light sources, generally providing better field homogeneity and avoiding the artifacts arising from residual (despite the use of diffracting elements) spatial and temporal coherence in the case of laser illumination.

In practical tests of the RES2 mode, exposure times per bitplane of a few ms have been found to be sufficient to generate useful images. By minimizing limitations by the camera characteristics (e.g. readout speed and noise, latency in rolling shutter mode, use of ROIs), high quality recordings from living cells at substantially >1 fps are possible.

The processing of conjugate and non-conjugate single aperture images in RES2 is described with reference to FIG. 5 with more detail as follows. A single DMD modulator element is selected as an excitation source leading to the (schematic) spot c and nc camera images of the emission (shown in FIGS. 5A and 5B). The two spot geometries are unrelated. For simplification it can be assumed that the camera gains are matched. The white pixels (number n_{ij,c},n_{ij,nc}) correspond to the respective masks generated by segmentation (step S3). The central dot in the c image of FIG. 5A is the computed position of the intensity-weighted centroid (step S4). The white pixels of the c image contain if, of, and background contributions. The background value b_{ij,c} is estimated locally and with high accuracy (by definition, no emission signal can be present) by dilating the mask 3, computing the mean v_{ij,c} of the difference mask (outer ring pixels), and multiplying by n_{ij,c}(b_{ij,c}=v_{ij,c}·n_{ij,c}); this value is small or negligible if one subtracts a global background (dark state) signal beforehand.

The of contribution can be estimated from the nc spot in FIG. 5B, which represents a unique capability of the inventive PAM. The nc spot exhibits a central (shown as black) pixel (experimental observation) corresponding to the position of the single selected modulator element on the contralateral side and thus with a background value. The dilated mask 3 in this case contains both of and background contributions, considered to be of equal density within the mask (v_{ij,nc}=of_{ij,nc}+b_{ij,nc}). However, if due to the spot pitch used, there is some superposition of contributions from adjacent spots, v_{ij,nc} is attenuated by a factor β≤1 (empirically ˜0.8, from calculation of normalized distributions in the masks and invoking non-negativity of computed ifᵢⱼ values). The corresponding of correction of the c signal is given by γv_{ij,c}np_{ij,c}; experience indicates that γ<<β, indicating that the very small aperture affords a very good sectioning capability, as is also indicated by the relative v values (b).

The following scheme shows the definitions of PAM signals in different resolution regimes. s_{ij,c} and s_{ij,nc} are the recorded c and nc signals corresponding to DMD modulator element (aperture) with index ij in a 2D DMD array 20. Each signal contains in-focus (if_{ij,c},of_{ij,c}), out-of-focus (if_{ij,nc},of_{ij,nc}), and background (b_{ij,c},b_{ij,nc}) contributions. The fractional distribution of the in-focus signal between the c and nc images is given by a, considered to be constant for any given DMD pattern and optical configuration; a varies greatly with aperture size, and serves to define the resolution ranges RES1,2, and 3 modes. For RES1 mode, the apertures are considered large enough so that the entire in-focus signal (ifᵢⱼ) is confined to c; thus α=1, and the desired net ifᵢⱼ signal is given by the indicated expression in which dc is the excitation duty cycle. In RES2 and RES2, the excitation (and thus “receiving”) aperture is significantly smaller than the diffraction limited Airy disk; that is, α<1 such that a fraction (which can exceed 90%) of ifᵢⱼ is now in nc. In RES3, the excitation psf is additionally “thinned” by depletion of the excited state by induced emission or photoconversion.

### General Relations

s_{ij,c}=if_{ij,c}+of_{ij,c}+b_{ij,c}

s_{ij,nc}=if_{ij,nc}+of_{ij,nc}+b_{ij,nc}

if_{ij,c}=α·ifᵢⱼ if_{ij,nc}=(1−α)·ifᵢⱼ

### RES1 mode

$$α = 1 {of}_{ij , c} = \frac{dc}{1 - dc} {of}_{ij , nc}$$

$${if}_{ij} = {if}_{ij , c} - {of}_{ij , nc} - {b}_{ij , c} = ( {s}_{ij , c} - {b}_{ij , c} ) - ( \frac{dc}{1 - dc} ) ( {s}_{ij , nc} - {b}_{ij , nc} )$$

### RES2, RES3 modes

α<1of_{ij,c}=of_{ij,nc}

ifᵢⱼ=if_{ij,nc}+if_{ij,c}=(s_{ij,nc}−βv_{ij,nc}np_{ij,nc})+(s_{ij,c}−(v_{ij,c}+γv_{ij,nc})np_{ij,c})

FIG. 6 shows examples of RES2 mode imaging. FIG. 6A shows an nc image of the same cell as in FIG. 4. The resolution of fine details is much greater, with fibers visible down to widths of single DMD elements (˜100 nm²). The sectioning is also extremely good, revealing structures in regions obscured in the RES1 images of FIG. 4. FIG. 6B shows an nc image of a cell stained for actin filaments with bodipy-phalloidin.

RES3 Mode—Superresolution Fluorescence Microscopy

Two major approaches are currently available for achieving resolution in fluorescence microscopy substantially below 100 nm. The molecular localization methods based on single molecule excited state dynamics (e.g. STORM method) are compatible with RES1 mode and possibly RES2 mode operation. In contrast, the “psf-thinning” methods based on excited state depletion (e.g. STED) and, particularly, molecular photoconversion (e.g. RESOLFT) protocols are ideally suited for the SAM method applied in a manner suitable for attaining the RES3 mode of lateral resolution. The PAM module permits bilateral illumination (see FIG. 1 and e.g. FIG. 1 and the description thereof in EP 2 369 401 A1). Thus, the creation of a depletion or photoconversion illumination (equivalent to the “donuts” in STED) is automatically and precisely achieved by exposing the sample to activation (and readout) light from one side and to depletion (or photoconversion) light from the opposite side, using the same pattern(s). The light sources can be employed simultaneously or displaced in time depending on the particular protocol and probe. As opposed to conventional RESOLFT in point scanning system, the entire field is addressed and processed simultaneously. Advantageously, no modification of the PAM optical set-up is required. In addition, it should be noted that the RES3 mode, contrary the conventional methods, provides optical sectioning. In an exemplary test of the RES3 mode for implementing the RESOLFT fluorescence measurement using a fluorescent protein expression system, a simple pulsed 488 nm diode laser is employed as an excitation light source for depletion by photoconversion.

Implementation of RES 1 to RES3 Modes with the Control Device of PAM 100

In the following, the methods of implementing the above PAM modes, preferably by software programs, are described with further details.

With regard to RES 1 mode, step S1 of the calibration procedure with the function of generating a calibration matrix of individual “dots” (selected modulator elements) includes a parameter definition. An origin parameter of defined active elements in the DMD array matrix (x,y offsets from global origin, e.g. upper left corner) and a space parameter representing spacing between adjoining element apertures in the 2D modulator DMD array matrix, the number nr of rows in the excitation matrix, the number nc of columns in the excitation matrix, and the number nbp of bitplanes in the overall sequence=space² are provided. A minimization of temporal overlap by randomization of the bitplane sequence such that successive bitplanes do not overlap with <n (usually=2) x or y displacements with na being the number of single element apertures in each bitplane=nr·nc. With an example: space=10; nbp=100; nr=95; nc=17; na=14917, total number of calibration spots=nbp·na=1,491,700.

Step S2 of the calibration procedure including the acquisition of calibration response matrices (conjugate, non-conjugate) includes the PAM operation with the pattern sequence (e.g consisting of matrix of single element apertures. A frontal illumination of the modulator, e.g. from the coupled microscope operated in transmission mode with Köhler adjustments establishing field homogeneity is provided. The acquisition of images corresponding to each bitplane in the sequence and live focusing adjustment is conducted so as to minimize spot size in the detector image (non-repetitive). The acquisition of images corresponding to the selected dot patterns is provided in a sequential manner. Preferably, corresponding background and shading images are collected for correction purposes. The operation is conducted with a given pattern sequence for the conjugate channel (recording from the same side as the illumination) and with the complementary pattern for the non-conjugate channel (recording from the side opposite to that of illumination). Subsequently, an averaging step can be conducted for averaging (computing means) of repeats of calibration data in calibration sessions.

Steps S3 to S5 include the processing of each bitplane calibration image so as to obtain an ordered set of vectored response parameters (by row and column of the modulator matrix). Firstly, bitplanes are reordered with an order according to known randomization sequence. Secondly, a segmentation (steps S3, S4) is conducted to identify and label response subimage (“spots”)-parameters: thresholds, dilation and erosion parameters; order arbitrary depending of degree of distortion (curvature and displacements of rows and columns). Subsequently, an output is generated, including a 2D mask and vectors by row and column. The output preferably further includes a 2D mask of pixel positions corresponding to pixel elements in given spot; an alpha (a) parameter (to be used in RES2 and RES3 modes), which represents relative intensity distributions in response pixels and calculation of response matrix of linear equations for composite bitplane image; coordinates of computed centroids of given spot; total intensity of given spot; and total area of given spot (in pixels). Thirdly, reordering of spots according to row and column of excitation modulator matrix is conducted, including providing coordinates of modulator excitation matrix for given bitplane and corresponding coordinates of response matrix for given bitplane (step S5). Finally, storage of vectors for recall during acquisition and processing is conducted. These steps are individually executed for conjugate (c) and non-conjugate (nc) image data.

In practice the calibration method works well even if solving >1 million linear equations in the 10 to 100 ms is required for real-time acquisition and display. Advanced software for sparse matrices (such as those involved here) utilizing multicore and GPU architectures are readily employed (e.g. SPARSE suite) for the calculation.

The software implementations of the RES2 and RES 3 modes include the following steps. Firstly, the acquisition of response matrices (conjugate, non-conjugate) is conducted, including a parameter selection and for RES3 mode additionally a selection of a pattern sequence (superpixel definition) for photoconversion and readout. Furthermore, X, Y, and Z positioning and spectral (excitation, emission, photoconversion) component selection (spectral channel definition) are conducted.

Secondly, backmapping of integrated response matrix (single exposure summed bitplane responses) to modulator element matrix is conducted. This registration uses centroid based calibration data (like in RES1 mode) and a local subimage processing algorithm, or alternatively a calibration based on the alpha parameter, wherein a solution of full or local alpha equation matrix using Sparse algorithms is used to generate distribution of individual responses in DMD space (with an individual execution for conjugate (c) and non-conjugate (nc) image data).

Thirdly, an evaluation of images acquired, e.g. with sparse patterns of small excitation spots is conducted, including a calculation of optically-sectioned images based on prior c and nc processing. With regard to the c image, centroid calibration data and local subimage processing algorithm are utilized for establishing distribution of response signals in camera domain and projection to DMD domain defined by the excitation patterns. With regard to the nc image, same as c but including a systematic evaluation of out-of-focus contributions by evaluation of signal immediately peripheral to calibration response area and suitably scaled subtraction from signals in the calibration response area. Finally, the image combination is conducted, wherein the optically-sectioning RES2 image is obtained from the processed nc image alone (the main contribution using very small excitation spots) or the scaled sum of the processed c and nc images.

The features of the invention disclosed in the above description, the figures and the claims can be equally significant for realizing the invention in its different embodiments, either individually or in combination or in sub-combination.

1-33. (canceled)

34. Optical confocal imaging method, being conducted with a programmable array microscope (PAM), having a light source device, a spatial light modulator device with a plurality of reflecting modulator elements, a PAM objective lens and a camera device, wherein the spatial light modulator device is configured such that first groups of modulator elements are selectable for directing excitation light to conjugate locations of an object to be investigated and for directing detection light originating from these locations to the camera device, and second groups of modulator elements are selectable for directing detection light from non-conjugate locations of the object to the camera device, comprising the steps of:
directing excitation light from the light source device via the first groups of modulator elements to the object to be investigated, wherein the spatial light modulator device is controlled such that a predetermined pattern sequence of illumination spots is focused to the conjugate locations of the object, wherein each illumination spot is created by at least one single modulator element defining a current PAM illumination aperture,
collecting image data of a conjugate image I_{c}, based on collecting detection light from conjugate locations of the object for each pattern of PAM illumination apertures,
collecting image data of a non-conjugate image I_{nc}, based on collecting detection light from non-conjugate locations of the object for each pattern of PAM illumination apertures via the second groups of modulator elements with a non-conjugate camera channel of the camera device, and
creating an optical sectional image (OSI) of the object based on the image data of the conjugate image I_{c} and the non-conjugate image I_{nc}, wherein
the step of collecting the image data of the conjugate image I_{c} includes
collecting a part of the detection light from the conjugate locations of the object for each pattern of PAM illumination apertures via modulator elements of the second groups of modulator elements surrounding the current PAM illumination apertures with the non-conjugate camera channel of the camera device.

35. Imaging method according to claim 34, wherein
the spatial light modulator device is controlled such that the current PAM illumination apertures have a diameter approximately equal to or below M*λ/2NA, with λ being a centre wavelength of the excitation light, NA being the numerical aperture of the objective lens and M a combined magnification of the objective lens and relay lenses between the modulator apertures and the object to be investigated.

36. Imaging method according to claim 34, wherein
each of the current PAM illumination apertures has a dimension below 100 μm

37. Imaging method according to claim 34, wherein
each of the PAM illumination apertures is created by a single modulator element.

38. Imaging method according to claim 34, wherein
for each of the PAM illumination apertures, individual modulator elements define a non-conjugate camera pixel mask surrounding a centroid of the camera signals of the non-conjugate camera channel of the camera device corresponding to the PAM illumination aperture,
each non-conjugate camera pixel mask is subjected to a dilation,
estimations of background non-conjugate signals are obtained from the dilated non-conjugate camera pixel mask for use as corrections of the image data of the non-conjugate (I_{nc}) and conjugate (I_{c}) images, and
an optical sectional image (OSI_{nc}) component corresponding to the non-conjugate camera channel of the camera device is formed.

39. Imaging method according to claim 34, wherein the step of forming the conjugate image I_{c} further includes
forming a partial conjugate image I_{c} by collecting via the first groups of modulator elements detection light from the conjugate and the non-conjugate locations of the object for each pattern of PAM illumination apertures with a conjugate camera channel of the camera device,
extracting the partial conjugate image I_{c} from the image collected with the conjugate camera channel of the camera device,
correcting the partial conjugate image I_{c} by subtracting an estimate of the non-conjugate contribution from the evaluation of the non-conjugate image I_{nc},
forming the optical sectional image (OSI_{c}) component corresponding to the I_{c} channel, and
forming the total optical sectional image (OSI) by combining the non-conjugate and conjugate contributions (OSI=OSI_{nc}+OSI_{c}).

40. Imaging method according to claim 39, wherein
for each of the PAM illumination apertures, individual modulator elements define a conjugate camera pixel mask surrounding a centroid of the camera signals of the conjugate camera channel of the camera device corresponding to the PAM illumination aperture,
the conjugate camera pixel masks are subjected to a dilation, and
estimations of background non-conjugate signals are obtained from the dilated conjugate camera pixel mask for use as corrections of the conjugate (I_{c}) and non-conjugate (I_{nc}) images so as to form the optical sectional image.

41. Imaging method according to claim 34, further including a calibration procedure with the steps of
illuminating the modulator elements with a calibration light source device,
creating a sequence of calibration patterns with the modulator elements,
recording calibration images of the calibration patterns with the camera device, and
processing the recorded calibration images for creating calibration data assigning each camera pixel of the camera device to one of the modulator elements.

42. Imaging method according to claim 41, including at least one of the features
the calibration patterns include a sequence of regular, preferably hexagonal, matrices of light spots each generated by at least one single modulator element, said light spots having non-overlapping camera responses,
the number of calibration patterns is selected such that all modulator elements are used for recording the calibration images and creating the calibration data, and
the sequence of calibration patterns is randomized such that the separation between modulator elements of successive patterns is maximized.

43. Imaging method according to claim 41, wherein
the camera pixels of the camera device responding to light received from the individual modulator elements provide a distinct, unique, stable distribution of relative camera signal intensities and their coordinates in the matrix of camera pixels, which are mapped to the corresponding modulator elements using the calibration procedure.

44. Imaging method according to claim 41, wherein
all collected images are accumulated and camera signals are mapped back to their corresponding originating modulator elements, wherein
centroids of the camera signals define a local sub-image in which intensities are combined by a predetermined algorithm so as to generate a signal intensity assignable to the corresponding originating modulator image element.

45. Imaging method according to claim 41, wherein
all collected images are accumulated and camera signals are mapped back to their corresponding originating modulator elements, wherein
every signal at every position in the image resulting from overlapping camera responses to an entire pattern sequence is represented as a linear equation with coefficients known from the calibration procedure, and
the corresponding emission signals impinging on the corresponding modulator elements are obtained by the solution to the system of linear equations describing the entire image.

46. Imaging method according to claim 41, wherein
the first groups of modulator elements are arrays of a low number (limit of 1) of elements with non-overlapping responses and the camera signals of individual modulator elements constitute a distinct, unique, stable distribution of relative signal intensities with coordinates in the matrix of camera pixels and in the matrix of modulation elements defined by the calibration procedure.

47. Imaging method according to claim 46, further including
simultaneous or time-shifted excitation with the same pattern with one or more light sources applied from a contralateral side.

48. Imaging method according to claim 41, wherein
the first group of modulator elements consist of 2D linear arrays of a low number (limit of 1) elements and the camera signals of individual modulator elements constitute a distinct, unique, stable distribution of relative signal intensities with coordinates in the matrix of camera pixels and in the matrix of modulation elements defined by the calibration procedure.

49. Imaging method according to claim 34, wherein
the light source device comprises a first light source being arranged for directing excitation light to the conjugate locations of the object and a second light source being arranged for directing excitation light to the non-conjugate locations of the object, and
the second light source is controlled for creating the excitation light such that the excitation created by the first light source is restricted to the conjugate locations of the object.

50. Imaging method according to claim 49, wherein
the second light source is controlled for creating a depleted excitation state around the conjugate locations of the object.

51. Imaging method according to claim 34, wherein
the detected light from the object is a delayed emission, such as delayed fluorescence and phosphorescence, such that aperture patterns for excitation and detection can be distinct and experimentally synchronized.

52. Optical confocal imaging method, being conducted with a programmable array microscope (PAM), having a light source device, a spatial light modulator device with a plurality of reflecting modulator elements, a PAM objective lens and a camera device, wherein the spatial light modulator device is configured such that first groups of modulator elements are selectable for directing excitation light to conjugate locations of an object to be investigated and for directing detection light originating from these locations to the camera device, and second groups of modulator elements are selectable for directing detection light from non-conjugate locations of the object to the camera device, comprising the steps of:
directing excitation light from the light source device via the first groups of modulator elements to the object to be investigated, wherein the spatial light modulator device is controlled such that a predetermined pattern sequence of illumination spots is focused to the conjugate locations of the object, wherein each illumination spot is created by at least one single modulator element defining a current PAM illumination aperture,
forming a conjugate image I_{c} by collecting detection light from conjugate locations of the object for each pattern of PAM illumination apertures via the first groups of modulator elements with a conjugate camera channel of the camera device,
forming a non-conjugate image I_{nc} by collecting detection light from non-conjugate locations of the object for each pattern of PAM illumination apertures via the second groups of modulator elements with a non-conjugate camera channel of the camera device, and
creating an optical sectional image (OSI) of the object based on the conjugate image I_{c} and the non-conjugate image I_{nc}, wherein
the conjugate image (I_{c}) and non-conjugate (I_{nc}) image are registered by employing calibration data, which are obtained by a calibration procedure including mapping positions of the modulator elements to camera pixel locations.

53. Programmable array microscope (PAM), having a light source device, a spatial light modulator device with a plurality of reflecting modulator elements, a PAM objective lens, a camera device and a control device, wherein the spatial light modulator device is configured such that first groups of modulator elements are selectable for directing excitation light to conjugate locations of an object to be investigated and for directing detection light originating from these locations to the camera device, and second groups of modulator elements are selectable for directing detection light from non-conjugate locations of the object to the camera device, wherein
the light source device is arranged for directing excitation light via the first groups of modulator elements to the object to be investigated, wherein the control device is adapted for controlling the spatial light modulator device such that a predetermined pattern sequence of illumination spots is focused to the conjugate locations of the object, wherein each illumination spot is created by at least one single modulator element defining a current PAM illumination aperture,
the camera device is arranged for forming collecting image data of a conjugate image I_{c}, based on detection light from conjugate locations of the object for each pattern of PAM illumination apertures,
the camera device includes a non-conjugate camera channel which is configured for collecting image data of a non-conjugate image I_{nc}, based on detection light from non-conjugate locations of the object for each pattern of PAM illumination apertures via the second groups of modulator elements, and
the control device is adapted for creating an optical sectional image (OSI) of the object based on the conjugate image I_{c} and the non-conjugate image I_{nc}, wherein
the non-conjugate camera channel of the camera device is arranged for collecting a part of the detection light from the conjugate locations of the object for each pattern of PAM illumination apertures via modulator elements of the second group of modulator elements surrounding the current PAM illumination apertures.

54. Programmable array microscope according to claim 53, wherein
the control device is adapted for to control the spatial light modulator device such that the current PAM illumination apertures have a diameter approximately equal to or below M*λ/2NA, with λ being a centre wavelength of the excitation light, NA being the numerical aperture of the objective lens and M a combined magnification of the objective lens and relay lenses between the modulator apertures and the object to be investigated.

55. Programmable array microscope according to claim 53, wherein
each of the current PAM illumination apertures has a dimension below 100 μm

56. Programmable array microscope according to claim 53, wherein
each of the PAM illumination apertures is created by a single modulator element.

57. Programmable array microscope according to claim 53, wherein
for each of the PAM illumination apertures, the individual modulator elements of the PAM illumination apertures define a non-conjugate camera pixel mask surrounding a centroid of the camera signals of the non-conjugate camera channel of the camera device corresponding to the PAM illumination aperture,
the control device is adapted for subjecting each non-conjugate camera pixel mask to a dilation, and
the control device is adapted for obtaining estimations of background non-conjugate signals from the dilated non-conjugate camera pixel mask for use as corrections of the conjugate image (I_{c}) and the non-conjugate (I_{nc}) image.

58. Programmable array microscope according to claim 53, wherein
the camera device includes a conjugate camera channel which is configured for forming a partial conjugate image I_{c} by collecting via the first groups of modulator elements detection light from the conjugate and the non-conjugate locations of the object for each pattern of PAM illumination apertures,
the control device is adapted for extracting the partial conjugate image I_{c} from the image collected with the conjugate camera channel of the camera device, and
the control device is adapted for forming the conjugate image I_{c} by superimposing the partial conjugate image I_{c} and the contribution extracted from the non-conjugate image I_{nc}.

59. Programmable array microscope according to claim 58, wherein
for each of the PAM illumination apertures, the individual modulator elements of the PAM illumination apertures define a conjugate camera pixel mask surrounding a centroid of the camera signals of the conjugate camera channel of the camera device corresponding to the PAM illumination aperture,
the control device is adapted for subjecting the conjugate camera pixel masks to a dilation, and
the control device is adapted for obtaining estimations of background non-conjugate signals from the dilated conjugate camera pixel mask for use as corrections of the conjugate image (I_{c}) and the non-conjugate (I_{nc}) image.

60. Programmable array microscope according to claim 53, wherein
the control device is adapted for conducting a calibration procedure with the steps of illuminating the modulator elements with a calibration light source device, creating a sequence of calibration patterns with the modulator elements, recording calibration images of the calibration patterns with the camera device, and processing the recorded calibration images for creating calibration data assigning each camera pixel of the camera device to one of the modulator elements.

61. Programmable array microscope according to claim 53, wherein
the light source device comprises a first light source being arranged for directing excitation light to the conjugate locations of the object and a second light source being arranged for directing excitation light to the non-conjugate locations of the object, and
the control device is adapted for controlling the second light source and creating the excitation light such that the excitation created by the first light source is restricted to the conjugate locations of the object.

62. Programmable array microscope according to claim 61, wherein
the control device is adapted for controlling the second light source and creating a depleted excitation state around the conjugate locations of the object.

63. Programmable array microscope (PAM), having a light source device, a spatial light modulator device with a plurality of reflecting modulator elements, a PAM objective lens, a camera device and a control device, wherein the spatial light modulator device is configured such that first groups of modulator elements are selectable for directing excitation light to conjugate locations of an object to be investigated and for directing detection light originating from these locations to the camera device, and second groups of modulator elements are selectable for directing detection light from non-conjugate locations of the object to the camera device, wherein
the light source device is arranged for directing excitation light from the light source device via the first groups of modulator elements to the object to be investigated, wherein the control device is adapted for controlling the spatial light modulator device such that a predetermined pattern sequence of illumination spots is focused to the conjugate locations of the object, wherein each illumination spot is created by at least one single modulator element defining a current PAM illumination aperture,
the camera device has a conjugate camera channel which is configured for forming a conjugate image I_{c} by collecting detection light from conjugate locations of the object for each pattern of PAM illumination apertures via the first groups of modulator elements,
the camera device has a non-conjugate camera channel which is configured for forming a non-conjugate image I_{nc} by collecting detection light from non-conjugate locations of the object for each pattern of PAM illumination apertures via the second groups of modulator elements, and
the control device is adapted for creating an optical sectional image of the object based on the conjugate image I_{c} and the non-conjugate image I_{nc}, wherein
the control device is adapted for registering the conjugate image (I_{c}) and the non-conjugate (I_{nc}) image by employing calibration data, which are obtained by a calibration procedure including mapping positions of the modulator elements to camera pixel locations.

64. Computer readable medium comprising computer-executable instructions controlling a programmable array microscope for conducting the method according to claim 34.

65. Computer program residing on a computer-readable medium, with a program code for carrying out the method according to claim 34.

66. Apparatus comprising a computer-readable storage medium containing program instructions for carrying out the method according to claim 34.
